(19) United States
(12) Patent Application Publication
(10) Pub. No.: US 2014/0225827 A1
(43) Pub. Date: Aug. 14, 2014

(54) SOFT BUTTON INPUT SYSTEMS AND METHODS

(71) Applicant: HEWLETT-PACKARD DEVELOPMENT COMPANY, L.P., Houston, TX (US)

(72) Inventors: David Quijano, Fort Collins, CO (US); Jonathan D. Bassett, Fort Collins, CO (US); Barry T. Phillips, Fort Collins, CO (US)

(21) Appl. No.: 14/346,004

(22) PCT Filed: Sep. 22, 2011
(86) PCT No.: PCT/US11/52715

§ 371 Date: Mar. 20, 2014

(51) Int. Cl. G06F 3/03

(52) U.S. Cl. CPC G06F 3/03
USPC 345/156

(57) ABSTRACT

Soft button systems and methods are provided. A soft button method can include disposing a machine readable pattern on a substrate and associating a portion of the machine readable pattern with at least one machine executable instruction set selected from a plurality of machine executable instruction sets. The method can, responsive to detecting the portion of the machine readable pattern, execute the at least one selected machine executable instruction set.

### BACKGROUND OF THE INVENTION

### Description of the Related Art

Graphics tablets are used throughout industry for precision design work involving everything from industrial equipment design to development of CGI animated feature films. Graphics tablets provide a means for entering data such as lines, curves, and shapes within a document, as well as a means for invoking commands based upon selection of various “buttons” built into the surface of the graphics tablet. The development of touch based user interfaces has opened a new era of design capabilities. Where previous generations used a graphics tablet to provide input for display, the current generation of ever-larger touch based displays affords the design professional the luxury of providing input at a 1:1 scale, directly upon a touch enabled display device.

### BRIEF DESCRIPTION OF THE DRAWINGS

Advantages of one or more disclosed embodiments may become apparent upon reading the following detailed description and upon reference to the drawings in which:

FIG. 1 is a block diagram depicting a sample soft button system using a machine readable pattern disposed on a substrate, according to one or more embodiments described herein; and

FIG. 2 is a flow diagram depicting a sample soft button method using a machine readable pattern disposed on a substrate, according to one or more embodiments described herein

### DETAILED DESCRIPTION

Touch based display systems enjoy an increasing share and acceptance within the professional and commercial markets more traditionally associated with distinct input and output/display devices such as graphics tablets and high performance displays. The availability of high performance, touch enabled, displays has provided the commercial, professional, and increasingly consumer, markets with the ability to perform design work, collaboration, animation, photo editing, and the like directly on the display device without the need for a standalone input device—the role formerly the domain of the graphics tablet.

Buttons are provided on graphics tablets for invoking functions or for providing control over the display area. For example, physical buttons for controlling the “zoom” of the display view are traditionally included on a graphics tablet. Some graphics tablets also provide a limited number of “user programmable” physical buttons providing quick access to various system functions, such as file open/close, etc. High performance, touch-enabled monitors however, are typically not provided with physical buttons. The lack of physical buttons on touch enabled display devices may limit the acceptance and/or usefulness of such devices as input/output devices capable of replacing the traditional graphics tablet.

Methods of providing soft button functionality are therefore provided. A soft button method can include disposing a machine readable pattern on a substrate and associating at least a portion of the machine readable pattern with at least one machine executable instruction set selected from a plurality of machine executable instruction sets. The method can, responsive to detecting the portion of the machine readable pattern, execute the at least one selected machine executable instruction set.

Soft button systems are also provided. A soft button system can include a substrate having a machine readable pattern disposed thereupon and a processor configurable to execute at least one instruction set associated with at least a portion of a physical location on the machine readable pattern; the at least one instruction set selected from a plurality of instruction sets.

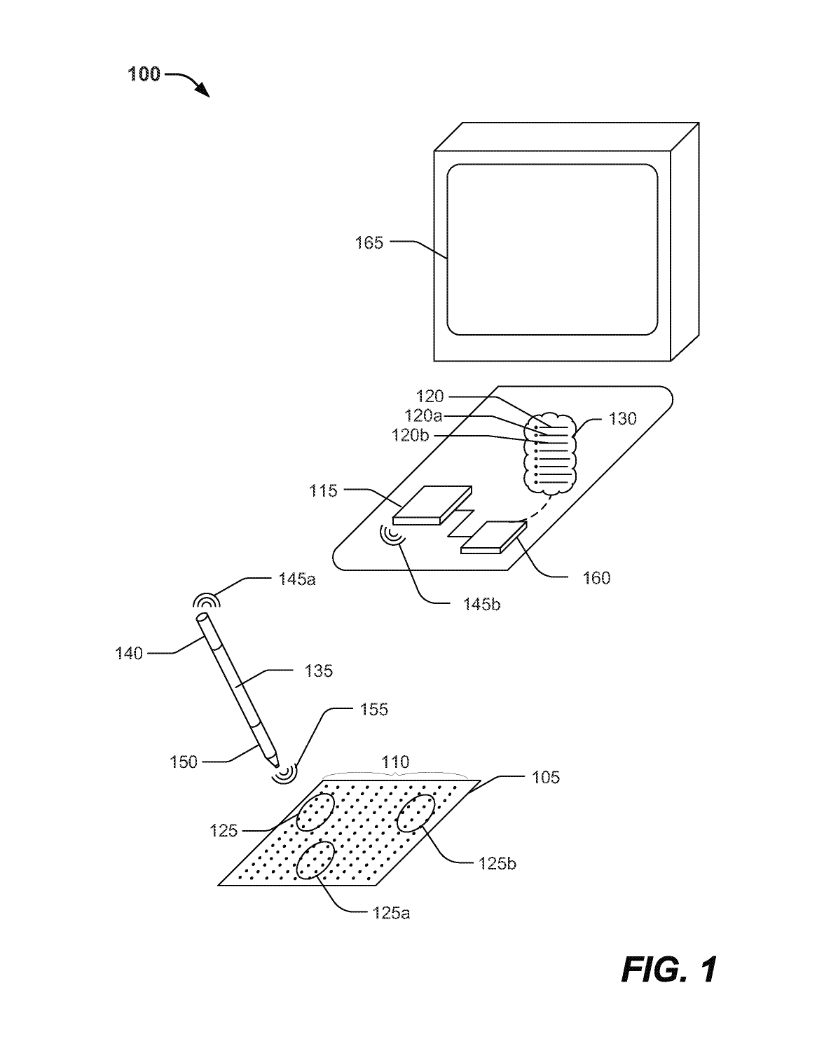

FIG. 1 is a block diagram depicting a sample soft button system 100 using a machine readable pattern on a substrate, according to one or more embodiments. The machine readable pattern 110 can be disposed on a rigid or semi-rigid substrate 105 such as a paper or plastic substrate. A processor 115 can associate a portion 125 of the machine readable pattern 110 with a machine executable instruction set 120. The machine executable instruction set 120 can be selected from a plurality of machine executable instruction sets 130.

The substrate 105 containing the machine readable pattern 110 can be disposed or otherwise affixed within a user's work area, for example on the bezel of a touch-enabled display device, or on a desk other surface within the reach of the user. Upon detection of at least a portion of the machine readable pattern 125, the processor 115 can execute one or more machine executable instruction sets 120. For example, upon detecting a first portion 125a of the machine readable pattern 110 the processor 115 may execute an instruction set 120a enabling a “zoom in” function on the currently displayed subject; conversely, upon detecting a second portion 125b of the machine readable pattern 110 the processor 115 may execute an instruction set 120b enabling a “zoom out” function on the currently displayed subject. In such a manner, the machine readable pattern 110 provides functionality similar to the hard buttons found on graphics tablets without requiring the physical presence of a hard button on a touch enabled display device.

The substrate 105 can include any material suitable for receiving and retaining the machine readable pattern 110. Such materials include rigid and semi-rigid materials such as plastic, paper, and the like. The substrate 105 may include a system, material, or fixative for attaching or otherwise permanently or temporarily affixing the substrate to another surface such as a monitor bezel, desktop, or similar surface. The substrate 105 can include a material suitable for the receipt of a printed machine readable pattern 110 provided by, for example, photolithographic reproduction, inkjet printing, laser printing, or the like. The substrate 105 can include laminated substrates, having multiple layers attached, affixed or otherwise bonded together, for example a paper substrate 105 containing a machine readable pattern 110 laminated or encased within a transparent plastic sleeve. Dependent upon the location of the substrate 105, the substrate may be either transparent or opaque. For example, a transparent substrate 105 may be used where the substrate is intended for attachment to a display surface where transparency is a desirable feature, while an opaque substrate 105 may be used where the substrate is intended for attachment to a dark surface such as a desktop or display bezel where transparency is not a desirable feature.

The machine readable pattern 110 can include any pattern, symbol, or group of symbols capable of being machine read, for example through the use of an appropriate detection device used as an input to the machine. A non-exclusive, non-limiting, example machine readable pattern 110 is that provided by Anoto® Group AB (Lund, Sweden). Using a unique, predetermined dot or element pattern such as that offered by Anoto®, a detector can uniquely discern, distinguish, or detect at least a portion of the pattern when placed proximate the pattern. By increasing the density of the dots (i.e., increasing the dot density by decreasing the distance between the elements, and possibly be decreasing the size of the elements themselves) the resolution capability of the detector is commensurately increased.

Based upon the unique encoded absolute positional information between the dots or elements forming the machine readable pattern 110, a detector can discern, distinguish or detect at least a portion of the machine readable pattern 110. Additionally, based upon the unique encoded absolute positional information between the dots or elements forming the machine readable pattern 110, the detector can determine its physical location with respect to the machine readable pattern 110. The pattern itself and the density dots or elements forming the machine readable pattern 110 contributes to the accuracy of the detector in discerning or distinguishing at least a portion of, and in determining its physical location with respect to, the machine readable pattern 110.

The machine readable pattern 110 may be printed, for example using an inkjet or laser printer on a suitable substrate 105. In some instances, the machine readable pattern 110 may be visible to the naked eye. For example, the machine readable pattern 110 may be comprised of small ink “dots” or elements printed on the substrate 105. Where the machine readable pattern 110 is visible, an optical detector may be used to discern or distinguish all or a portion of the machine readable pattern 110. in other instances, the machine readable pattern 110 may be invisible to the naked eye. For example, the machine readable pattern 110 may comprise infrared (“IR”) or ultraviolet (“UV”) sensitive “dots” or elements printed on the substrate 105. Where at least a portion of the machine readable pattern 110 is invisible to the naked eye, a detector having an appropriate IR or UV emitter and receiver may be used to discern or distinguish all or a portion of the IR or UV sensitive machine readable pattern 110.

Other machine readable patterns 110 can be used with similar performance, for example barcodes and quick response (QR) codes may be used in lieu of the Anoto® dot pattern described in detail above. Where other machine readable patterns 110 are used, a detector and logic sensitive to the specific type of machine readable pattern 110 are employed.

At least a portion 125 of the machine readable pattern 110 is communicated to the processor 115. Based upon the portion 125 of the machine readable pattern 110 provided to the processor 115, the processor 115 executes at least one machine executable instruction set 120 selected from a plurality of machine executable instruction sets 130. The processor 115 includes any device capable of executing the machine executable instruction set 120. For example, the processor 115 may incorporate two or more cores disposed within a single processor or two or more physically discrete processors.

The at least one machine executable instruction set 120 may be disposed in whole or in part within the processor 115 or disposed in whole or in part within a memory or storage module 160 in bi-directional communication 145a, 145b with the processor 115. The at least one machine executable instruction set 120 may affect or otherwise impact one or more functional aspects of the display 165, for example altering one or more display parameters such as zooming in to or out from the display image. The at least one machine executable instruction set 120 may affect or otherwise impact one or more machine functions, for example saving the display image data to a computer data file in the memory module 160.

The portion 125 of the machine readable pattern 110 provided to the processor 115 can determine the specific instruction set 120 selected and executed from the plurality of instruction sets 130. For example, the machine readable pattern 110 may be divided into a plurality of portions 125, 125a, and 125b. Communication of a first portion 125a may cause the processor 115 to execute a first machine executable instruction set 120a, while communication of a second portion 125b may cause the processor 115 to execute a second machine executable instruction set 120b. In a like manner, the machine readable pattern 110 may be apportioned into any number of portions 125 corresponding to a number of unique machine executable instruction sets 120 forming the plurality of machine executable instruction sets 130.

Transmission of at least a portion 125 of the machine readable pattern 110 communicated to the processor 115 is accomplished using any analog or digital, wired or wireless, single or two-way, data communication method. An illustrative wireless communication system is depicted in FIG. 1 although other systems can be employed to communicate the portion 125 of the machine readable pattern 110 to the processor 115. The handheld member 135 can include a member such as a pen or similar drawing device used to provide input to the touch enabled display 165.

The sample system 100 depicted in FIG. 1 depicts a handheld member 135 capable of detecting 155 at least a portion 125 of the machine readable pattern 110 and communicating detected portion 125 of the machine readable pattern 110 to the processor 115. The handheld member 135 includes a transceiver 140 capable of establishing two way communications 145a, 145b, for example using Bluetooth® or similar RF technology, between the member 135 and the processor 115.

The handheld member 135 includes an additional transceiver 150 disposed at least partially within the member 135. The transceiver 150 is configured to detect at least the portion 125 of the machine readable pattern 110 using one or more detection capabilities 155, for example optical, IR, or UV detection capabilities. The handheld member 135 may additionally include one or more IR or UV emitters where an IR or UV sensitive machine readable pattern 110 is employed. Thus, as depicted in the example provided by FIG. 1, the handheld member 135 includes at least three different functions: (a) a data entry tool suitable for use with the touch enabled display 165; (b) a detection tool having a transceiver 150 with detection capabilities 155 suitable for detecting the machine readable pattern 110; and (c) a communications tool linking the handheld member 135 to the processor 115 using a transceiver 140 and a two-way communications link 145a, 145b.

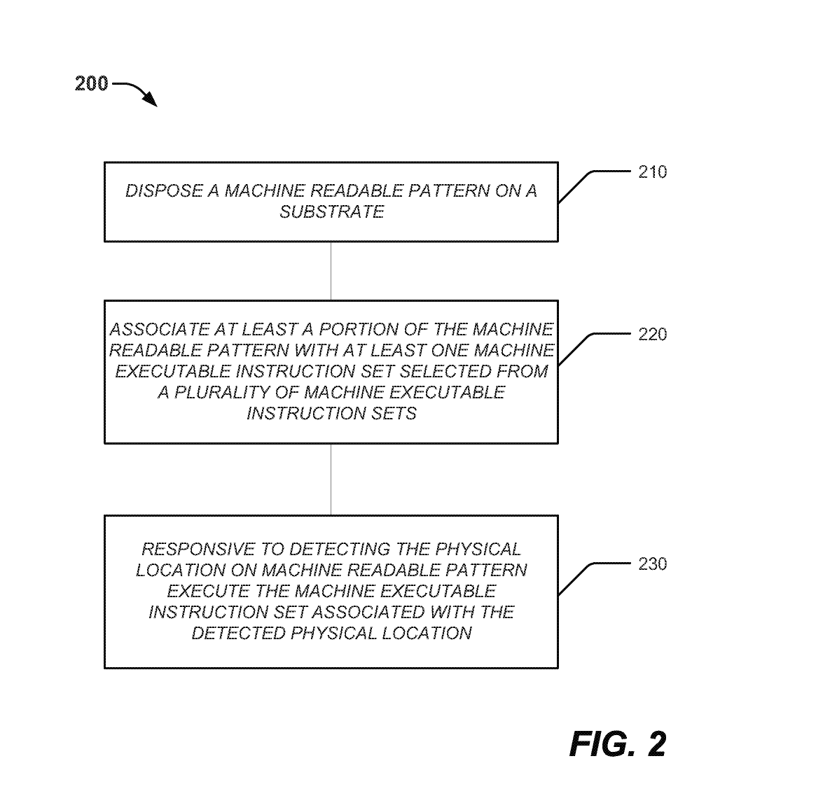

FIG. 2 is a flow diagram depicting a sample soft button method 200 using a machine readable pattern 110 on a substrate 105, according to one or more embodiments. The method 200 includes disposing a machine readable pattern 110 on a substrate 105 at 210. At least a portion 125 of the machine readable pattern 110 is associated with at least one machine executable instruction 120 set selected from a plurality of machine executable instruction sets 130 at 220. in response to detecting the portion 125 of the machine readable pattern 110, the at least one selected machine executable instruction set 120 is executed by the processor 115 at 230.

At 210 a machine readable pattern 110 is disposed on a substrate 105. The machine readable pattern 110 includes any two-dimensional pattern or code disposed on a substrate. Non-limiting examples include, but are not limited to visible patterns such as the Anoto® dot pattern, quick response (OR) codes, and bar codes as well as patterns that are partially or completely invisible such as patterns and codes visible only in the infrared or ultraviolet spectrum. The machine readable pattern 110 can be disposed on the substrate 105 using any printing technology, for example photolithography or offset printing, as well as conventional printing techniques such as inkjet or laser printing on a suitable substrate.

At 220 at least a portion 125 of the machine readable pattern 110 is associated with at least one machine executable instruction 120 set selected from a plurality of machine executable instruction sets 130. The machine readable pattern 110 can contain a plurality of portions or regions 125. Each of the portions or regions 125 of the machine readable pattern 110 can correspond, correlate or be associated with one or more machine executable instruction sets 120. For example, with a machine readable pattern 110 divided into four portions 125, each of the portions 125 may correspond to different machine executable instruction sets 120. The first portion may correspond to an instruction set that zooms in on a display object; the second portion may correspond to an instruction set that zooms out from a display object; the third portion may correspond to an instruction set that saves the displayed image to a memory or storage 160; the fourth portion may correspond to an instruction set that deletes a portion of a display object.

The association between a physical location or portion of the machine readable pattern 110 and the machine executable instruction set 120 can be established automatically, for example when the machine readable pattern itself contains at least a portion of the instruction set, or when the processor 115 accesses a read only memory containing association data linking portions 120 of the machine readable pattern 110 to specific machine executable instruction sets 120. At other times, the association between a physical location or portion of the machine readable pattern 110 and the machine executable instruction set 120 can be established manually by a user, for example through the use of a user interface facilitating the linkage between a portion 125 of the machine readable pattern 110 and a specific instruction set 120.

At 230, responsive to detecting the portion 125 of the machine readable pattern 110, the at least one selected machine executable instruction set 120 is executed by the processor 115. At least a portion 125 of the machine readable pattern 110 can be detected 155 and communicated 145a, 145b to the processor 115, for example using an intermediate device such as the handheld member 135 described in detail with respect to FIG. 1. The processor 115, at least partially in response to the detected portion 125 of the machine readable pattern 110, can select a machine executable instruction set 120 from a plurality of machine executable instruction sets 130 for execution. The instruction set 120 may affect one or more system parameters, for example one or more touch-enabled display 165 parameters. The plurality of machine executable instruction sets 130 may be stored at least partially within the processor 115 itself, or at least partially within a memory or storage 160 communicatively coupled to the processor 115.

The method 200 can be incorporated into a non-transitory computer readable medium including magnetic storage media such as disk drives and solid state drives, optical storage media such as CD, DVD, and Blu-Ray; and electromagnetic storage media such as universal serial bus (USB) and secure digital (SD) flash drives. The method incorporated into the computer readable media can include logic which when executed by the processor 115 can in response to the receipt of at least a portion of a machine readable pattern 125, cause the processor to select at least one instruction set 120 associated with the portion of the machine readable pattern; the at least one instruction set selected from a plurality of instruction sets 130. The method can then cause the processor 115 to execute the selected at least one instruction set.

The computer readable media can further include instructions, which when executed by the processor 115, cause the processor to provide an interface to permit a user to select the at least one instruction set associated with at least a portion of the machine readable pattern. Instructions permitting the user to associate the machine executable instruction set 120 with at least a portion 125 of the machine readable code 110 can be useful for providing the user with a configurable system and method for implementing various functionality based upon the content of the machine readable pattern 110. For example, a first user might prefer a portion of the machine readable pattern 110 be associated with a display “zoom in” functionality, while a second user might prefer the same portion of the machine readable pattern 110 be associated with a display “zoom out” functionality. Instructions included on the CRM to enable each user to customize the association of the same section of the machine readable pattern 110 with a different machine executable instruction set 120 can provide the desired flexibility.

The computer readable media can additionally include instructions, which when executed by the processor 115, cause the processor to output the machine readable pattern to a device, such as an inkjet or laser printer, capable of disposing the pattern on an appropriate substrate such as plastic, paper, or the like.

The problem of providing stand alone soft button controls is solved by generating a machine readable pattern; associating the machine readable pattern with a machine executable instruction set; and executing the machine executable instruction set after detecting the machine readable pattern.

What is claimed is:

1. A soft button method, comprising:
disposing (210) a machine readable pattern on a substrate;
associating (220) at least a portion of the machine readable pattern with at least one machine executable instruction set selected from a plurality of machine executable instruction sets; and
responsive to detecting the portion of the machine readable pattern, executing (230) the at least one selected machine executable instruction set.

2. The method of claim 1, wherein disposing a machine readable pattern on a substrate comprises:
disposing a unique pattern of machine readable elements on the substrate; the unique pattern of machine readable elements associable with a unique physical location on the substrate.

3. The method of claim 1, wherein detecting the portion of the machine readable pattern comprises:
generating a signal;
reflecting at least a portion of the signal from the machine readable pattern; and
identifying at least a portion of the machine readable pattern based upon at least one parameter associated with the reflected signal.

4. The method of claim 3, wherein generating a signal comprises:
generating an electromagnetic signal in the infrared portion of the electromagnetic spectrum extending from about 800 nm to about 3000 nm.

5. The method of claim 2, wherein disposing a unique pattern of machine readable elements comprises:
printing a predetermined pattern of elements; the elements at least partially reflective to electromagnetic radiation falling in the infrared electromagnetic spectrum from about 800 nm to about 3000 nm.

6. The method of claim 2, wherein disposing a unique pattern of machine readable elements comprises:
printing a predetermined pattern of elements; the elements at least partially visible in the visible electromagnetic spectrum from about 300 nm to about 800 nm.

7. A soft button system, comprising:
a substrate (105) including a machine readable pattern (110);
a processor (115) configurable to execute at least one instruction set (120) associated with at least a portion (125) of the machine readable pattern; the at least one instruction set selected from a plurality of instruction sets (130).

8. The system of claim 7, further comprising:
a handheld member (135) to
detect (155) the machine readable pattern; and
transmit (145a, 145b) the detected portion of the machine readable pattern to the processor.

9. The system of claim 7, the machine readable pattern comprising a predetermined pattern of elements; the elements including at least one of: elements at least partially reflective to electromagnetic radiation falling in the infrared electromagnetic spectrum from about 800 nm to about 3000 nm; or elements at least partially visible in the visible electromagnetic spectrum from about 300 nm to about 800 nm.

10. The system of claim 8, the handheld member comprising:
a transmitter (150) to generate an electromagnetic signal in the infrared electromagnetic spectrum from about 800 nm to about 3000 nm;
a receiver to measure a reflected electromagnetic signal reflected by the machine readable pattern; and
an RF transceiver (140) to communicatively couple the handheld transceiver with the processor.

11. The system of claim 7, further comprising:
a memory (160) to store the plurality of instruction sets.

12. The system of claim 7, wherein the at least one instruction set selected from the plurality of instruction sets is user selectable.

13. A non-transitory computer readable medium comprising instructions that, when executed by a processor, cause the processor to:
responsive to the receipt of at least a portion of a machine readable pattern, select at least one instruction set associated with the portion of the machine readable pattern; the at least one instruction set selected from a plurality of instruction sets; and
execute the selected at least one instruction set.

14. The non-transitory computer readable medium of claim 13 further comprising instructions that, when executed by a processor, cause the processor to:
provide an interface to permit a user to select the at least one instruction set associated with at least a portion of the machine readable pattern.

15. The non-transitory computer readable medium of claim 13 further comprising instructions that, when executed by a processor, cause the processor to:
dispose the machine readable pattern on a substrate.
